(19) United States
(12) Patent Application Publication
(10) Pub. No.: US 2017/0248629 A1
(43) Pub. Date: Aug. 31, 2017

(54) METHOD FOR OPERATING A MICROMECHANICAL Z-ACCELEROMETER

(71) Applicant: Robert Bosch GmbH, Stuttgart (DE)

(72) Inventors: Kay Hammer, Reutlingen (DE); Axel Franke, Reutlingen (DE); Sebastian Guenther, Tuebingen (DE)

(21) Appl. No.: 15/438,040

(22) Filed: Feb. 21, 2017

(30) Foreign Application Priority Data
Feb. 29, 2016 (DE) 102016203153.8

(51) Int. Cl. G01P 15/125; G01P 21/00

(52) U.S. Cl. CPC G01P 15/125; G01P 21/00

(57) ABSTRACT

A method for operating a micromechanical z-accelerometer. The method includes applying a test signal to an electrode in order to induce a defined displacement of a rocker of the z-accelerometer during operation of the z-accelerometer; detecting the displacement of the rocker and converting the displacement into an acceleration value; and evaluating the acquired acceleration value by determining a difference between the acquired acceleration value and an initial acceleration value acquired in a manufacturing process, a difference between the acquired acceleration value and the initial acceleration value being compared to a defined threshold value and assessed.

### CROSS REFERENCE

The present application claims the benefit under 35 U.S.C. §119 of German Patent Application No. DE 102016203153.8 filed on Feb. 29, 2016, which is expressly incorporated herein by reference in its entirety.

### FIELD

The present invention relates to a method for operating a micromechanical z-accelerometer. The present invention further relates to a micromechanical z-accelerometer.

### BACKGROUND INFORMATION

MEMS-based accelerometers and micromechanical accelerometers are used these days in great numbers for consumer applications and applications in the automotive sector, both individually and integrated into an inertial measurement unit (IMU) with a gyroscope and/or as compass with a magnetic sensor.

The sensors are calibrated during production and sometimes also after assembly in an application or terminal device, so that sensitivity errors and zero-point errors (offset) are minimized. In so doing, the aim is that neither a sensitivity nor an offset of the sensor will drift over an operational life of the sensor. However, various non-idealities (e.g., package influences, charge drifts, etc.) in the system lead to smaller or perhaps greater drifts of acceleration values over the operational life of the sensor. They are difficult to distinguish from actual acceleration values, which is why an offset of the acceleration value that has come about is only able to be detected under defined conditions (e.g., rest position or known orientation), and possibly corrected.

For a simple functional test, accelerometers include a built-in test function (BITE) that emulates an applied acceleration with the aid of an electrostatic displacement. The built-in test signal is usually also checked on the assembly line when calibrating the sensors and upon installation at the customer site.

In the application device, the sensors are generally operated with the aid of software (e.g., device drivers, function-expanding software, etc.).

Conventional sensors for measuring physical acceleration usually have a micromechanical structure made of silicon (sensor core) and evaluation electronics. Sensor cores, which make it possible to measure an acceleration in a direction orthogonal to a main plane of the sensor core, are known as z-sensors. Such sensors are used in the automotive sector, e.g., in ESP systems, or in the consumer sector, for example, in wireless telephony.

### SUMMARY

An object of the present invention is to provide an improved method for operating a micromechanical z-accelerometer.

The objective is achieved according to a first aspect by a method for operating a micromechanical z-accelerometer, having the following steps:
Applying a test signal to an electrode in order to induce a defined displacement of the rocker of the z-accelerometer during operation of the z-accelerometer;
Detecting displacements of the rocker and converting the displacements into an acceleration value; and
Evaluating the acquired acceleration value by determining a difference between the acquired acceleration value and an initial acceleration value acquired in a manufacturing process, a difference between the acquired acceleration value and the initial acceleration value being compared to a defined threshold value and assessed.

In this way, by acquiring and evaluating an acceleration value in the field and comparing the acceleration value to an initial acceleration value, it is possible to recognize a charge drift that has occurred. This may be explained in that, due to the drifting away of the electric charges over the course of time, altered acceleration values are generated, which take effect as an offset of the acceleration values. The detected charge drift may be used expediently in various ways. In this manner, design specifications of the z-accelerometer may advantageously be taken into account. The method may be categorized advantageously for entire sensor families or for types of sensors.

According to a second aspect, the objective may be achieved by a micromechanical z-accelerometer, having, for example:
a determination device for determining acceleration values of the z-accelerometer; and
a recognition device which is functionally connected to the determination device and is designed to recognize and assess a difference between an initial acceleration value and an acceleration value acquired during operation of the z-accelerometer.

Preferred specific embodiments of the method according to the present invention and the z-accelerometer according to the present invention are described herein.

One advantageous further refinement of the method is characterized in that the acceleration value is acquired repeatedly at defined time intervals. In this way, the influence of disturbances may be largely ruled out or at least reduced during the acquisition of the acceleration value.

A further advantageous development of the method provides for determining a correlation between an acceleration value acquired without applied test signal and an acceleration value acquired with applied test signal, the correlation having the following mathematical function:

Offsetdrift=C0+C1*(B1−B0)

C0, C1 . . . design-specific coefficients

the correlation being used for a correction of the acceleration value determined during operation of the z-accelerometer. A correction of the acceleration value may thus be used in particular for a non-safety-critical application of the z-accelerometer in a consumer-electronics application such as a cell phone, tablet, game console, etc.

A further advantageous development of the method provides that the test signal and an algorithm for recognizing and correcting an offset drift of the z-accelerometer are controlled with the aid of a computer program product. Thus, it is advantageously possible to carry out and modify the method in an easy manner.

One advantageous further refinement of the micromechanical z-accelerometer is characterized in that the initial acceleration value and design-specific coefficients for correcting an offset drift of the acceleration value are stored in a memory of the z-accelerometer. Advantageously, a possibility that is easy to realize is thus provided for storing the initial acceleration value.

A further advantageous refinement of the micromechanical z-accelerometer is characterized in that the acceleration value is correctable with the aid of a correction device. The effect of the charge drift may thus be corrected during operation of the accelerometer, thereby promoting convenient operation of a terminal device having the z-accelerometer.

The present invention is described in detail below with further features and advantages on the basis of several figures. In this context, all features described, alone or in any combination, constitute the subject matter of the present invention, regardless or their presentation in the description or in the figures, and regardless of their combination herein. The figures are not absolutely true to scale.

Disclosed method features are obtained analogously from corresponding disclosed device features and vice versa. In particular, this means that features, technical advantages and embodiments relating to the method for operating a micromechanical z-accelerometer are obtained in analogous manner from corresponding embodiments, features and advantages relating to a micromechanical z-accelerometer and vice versa.

### BRIEF DESCRIPTION OF THE DRAWINGS

FIG. 1 shows a representation of a micromechanical z-accelerometer in principle.

FIG. 2 shows a histogram with a graphically depicted effective-path hypothesis for representing a charge drift.

FIG. 3 shows a representation in principle of acceleration values of z-accelerometers after a calibration process and prior to a service-life stress.

FIG. 4 shows a representation in principle of acceleration values of the z-accelerometers of FIG. 3 after a service-life stress.

FIG. 5 shows a representation in principle of a mode of operation for recognizing charge drifts in the case of z-accelerometers.

FIG. 6 shows a flow chart in principle of one specific embodiment of the method according to the present invention.

FIG. 7 shows a block diagram of one specific embodiment of the proposed micromechanical z-accelerometer.

FIG. 8 shows a block diagram of a further specific embodiment of the proposed micromechanical z-accelerometer.

### DETAILED DESCRIPTION OF EXAMPLE EMBODIMENTS

In accordance with the present invention, an offset drift in a z-channel of a micromechanical accelerometer due to charge drifts is made recognizable. In so doing, it is especially advantageous that the micromechanical z-accelerometer does not have to be in a special state or rest position for that purpose.

The description below relates to an evaluation method used in the case of current consumer accelerometers (e.g., for cell phones, tablets, etc.). Automotive accelerometers may possibly behave differently; however, the fundamental acting principles are the same as for consumer accelerometers.

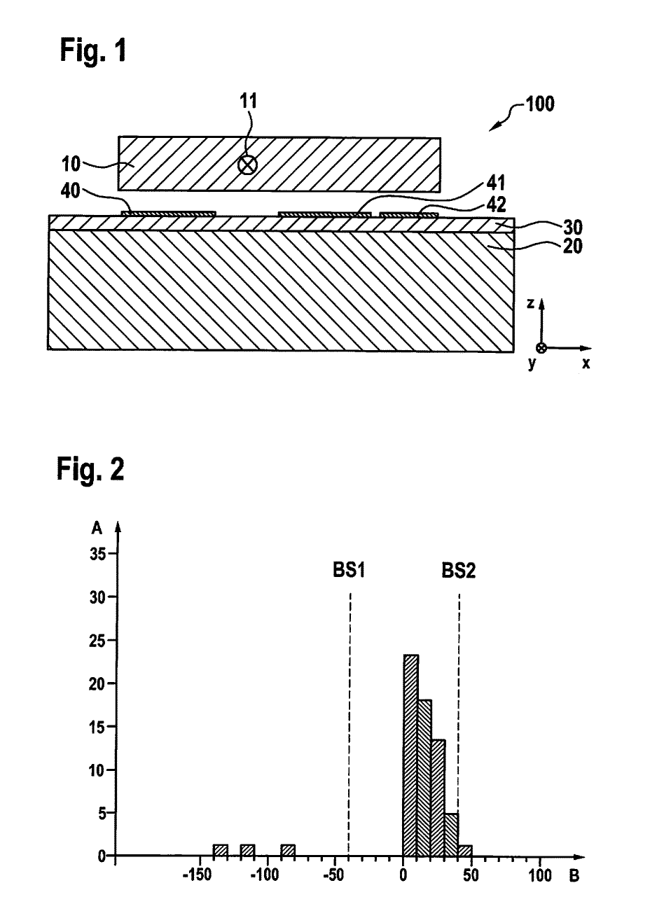

A capacitive z-accelerometer usually detects by displacement out of the plane. A rocker structure provided for that purpose is illustrated in principle, and not true to scale in a cross-sectional view in FIG. 1. A z-accelerometer 100 is shown, having a rocker 10 which is formed in the polysilicon level. Rocker 10 is made asymmetrical with the aid of an additional mass formed in the right area.

As the result of an acceleration (vertical acceleration in the z-direction) acting orthogonally relative to a main plane of rocker 10, the structure of rocker 10 is able to twist about torsion axis 11 due to the asymmetry of the two rocker arms. Below rocker 10, a sensor substrate 20 is discernible, on which an oxide 30 is located. Situated on oxide 30 are electrodes 40, 41 and 42 in order to realize a capacitive evaluation concept for micromechanical z-accelerometer 100.

A plurality of mechanical stop elements (not shown) are intended to ensure that in the event of overload, the rocker structure strikes the substrate at defined points, and are meant to prevent rocker 10 from reaching or exceeding a critical displacement in response to lateral overload accelerations. The displacement is converted by the distance-caused change of the capacitance between the movable mass of rocker 10 and a stationary electrode, into an electrical signal. To that end, electric voltage pulses are applied between the fixed electrode and the movable mass. These voltage pulses lead to an additional electrostatic force on the movable mass of rocker 10, which is proportional to the square of the effective value of this electric voltage and displaces the mass of rocker 10 further in the direction of the fixed electrode (attracting force).

A change in inclination of rocker 10 is detected with the aid of an electronic evaluation device (not shown) by sensing and evaluating charge changes on electrodes 40, 41, 42. In this manner, it is possible to determine a vertical acceleration acting in the z-direction on micromechanical z-accelerometer 100.

By the nature of the process (e.g., due to electrochemical deposition processes), there are electric charges on the surfaces, thus, also on the movable mass of rocker 10, the charges corresponding to an electric surface potential. Upon conversion of the displacement into electrical signals, the electric voltage is thereby falsified. This is not a problem so long as the indicated electric surface charges remain constant. However, if a charge drift occurs over an operating time of z-accelerometer 100, the electrostatic force also drifts, resulting in the additional displacement of the movable mass of rocker 10 as well, and by implication, also the output signal (“acceleration signal”) of z-accelerometer 100. Thus, a drift of a zero-point error (offset drift) comes about, whose effect is represented in principle with reference to FIG. 2 in a histogram.

FIG. 2 shows qualitatively an effect of a charge drift in the case of micromechanical z-accelerometers. An acceleration B is scaled on the x-axis and a number A of z-accelerometers is scaled on the y-axis. Two threshold values BS1, BS2 represented by broken lines on the x-axis define allowed limits of acceleration values of z-accelerometers. One can see that some z-accelerometers lie outside of limits BS1, BS2, the position of the z-accelerometers outside of limits BS1, BS2 having been caused by charge drifts.

An electric test signal is used first and foremost for a rapid functional test of micromechanical z-accelerometer 100, an acceleration being emulated on rocker 10 with the aid of an additional electrostatic force produced by the test signal. For example, this is accomplished by a change in the clocking scheme of the capacitive conversion in such a way that in one phase, a net force occurs. This corresponds to an acceleration between approximately several 100 mg and approximately several g. This electrostatic force is also falsified by the existing electric surface charges. The result of this, in turn, is that in the case of a charge drift, an output signal of the sensor, which is interpreted as an acceleration value, also shifts correspondingly.

The offset drifts indicated are difficult to detect in the field. A recognition and correction independent of the user are possible only with the aid of costly algorithms (for example, with conventional Kalman filters described, e.g., in German Patent Application No. DE 10 2009 029 216 A1), and hence also only in very limited fashion. If the offset drifts are to be traced back to charge drifts, one possibility for detection and correction described hereinafter is obtained based on the operative connections outlined above.

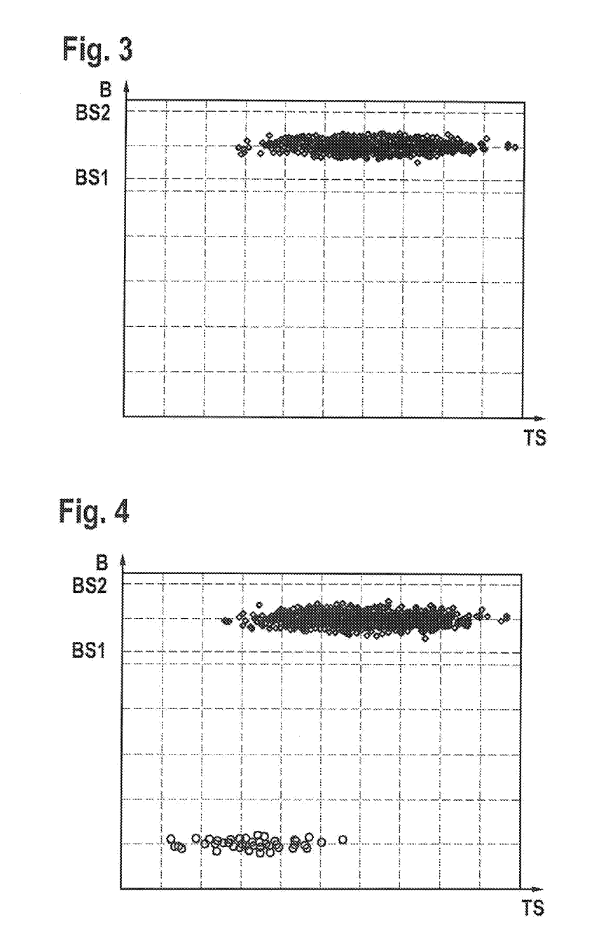

This is indicated in principle with the aid of FIGS. 3 through 5 with dimensionless values.

FIG. 3 shows a distribution of acceleration values in connection with many z-accelerometers prior to an influence of service-life stress, a test signal TS being scaled dimensionlessly on the x-axis. On the y-axis having dimensionlessly scaled acceleration B, one can see upper limit BS2 and lower limit BS1, which correspond to the limits of FIG. 2, between which permitted values of accelerations of micromechanical z-accelerometers are allowed to lie. It is clear that the acceleration values of all z-accelerometers are between limits BS1 and BS2, that is, all z-accelerometers are within the allowed range.

FIG. 4 shows a distribution of the acceleration values of the z-accelerometers from FIG. 3 after the influence of service-life stress (e.g., due to temperature influences, changing environmental conditions, etc.), which, due to charge drifts, has led in the case of some of the z-accelerometers to the result that their acceleration values lie outside of the allowed limits or limiting values BS1, BS2 (lower area of FIG. 4). As a consequence, these z-accelerometers have drifted in their acceleration value by approximately several 100 mg, which means an unwanted offset of the acceleration value has been generated.

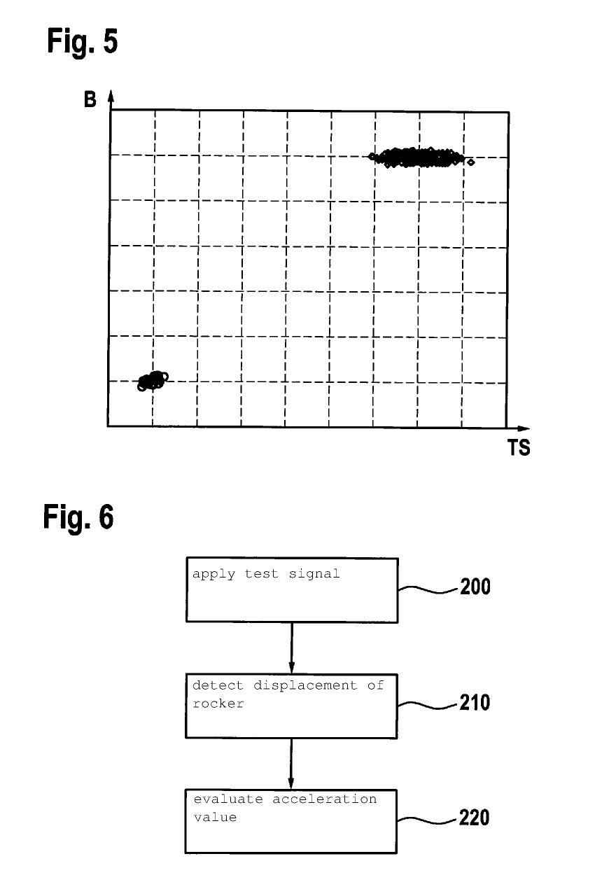

FIG. 5 shows qualitatively the drift of the acceleration value that has taken place between the state of the z-accelerometer without service-life stress and the state of the z-accelerometer with service-life stress, those z-accelerometers being located in a lower left area of FIG. 5 for which a charge drift has taken place, which means the acceleration values have drifted as a consequence. As a result, a clearly recognizable group of “poor, drifted” z-accelerometers (FIG. 5 bottom left) is thereby identifiable, that is clearly distinguishable from the reference group of “good, non-drifted” z-accelerometers (FIG. 5 top right).

This pattern may be used in the field in the case of z-accelerometers to recognize the offset drift of the acceleration. The following steps are provided for that purpose:

First of all, at a first point in time (during calibration of the sensor by the manufacturer, or upon installation of the z-accelerometer in an application device or terminal device) an initial acceleration value B0 in response to activated test signal is determined. Preferably, this takes place at the end of the assembly line and corresponds to an initial calibration and acquisition of a first acceleration value B0 of the z-accelerometer.

This acquired initial acceleration value B0 is thereupon saved or stored in a memory area of micromechanical z-accelerometer 100. Alternatively, initial acceleration value B0 may also be stored in the application device in which the z-accelerometer is installed.

During the regular operation of micromechanical z-accelerometer 100, the indicated electrical test signal is applied at defined time intervals in order to determine acceleration value B1 in regular operation.

In the process, determined acceleration value B1 is in each case compared to initially acquired acceleration value B0. For example, the comparison may be carried out with the aid of a defined threshold value, which determines whether or not a charge drift has taken place.

Finally, in the event the indicated threshold value is exceeded, it is recognized that a charge drift has taken place, an offset of the acceleration value being recognized in case the threshold value has been exceeded.

In advantageous variants of the method, in order to rule out disturbances (for example, due to a movement of the application device) during the measurement of acceleration value B1, it may be provided to repeat the measurements several times or perhaps to modulate them. Advantageously, it may be provided to have the detection algorithm run directly in a driver of z-accelerometer 100 for the system of the application device, or in a microcontroller present in z-accelerometer 100. Furthermore, a significance test may also be provided which, for a comparison of the difference between acceleration value B1 and stored initial value B0 with the threshold value, additionally takes customary fluctuations of the measured values in the environment of the instantaneous measurement into account.

In this way, ultimately it is advantageously possible to recognize a charge drift that has occurred within the z-accelerometer.

In one advantageous further refinement of the method, it is possible, particularly in the case of applications not critical with regard to safety, to correct the recognized charge drift. In this case, for example, in applications for accelerometers in the consumer sector (e.g., for cell phones, tablets, etc.), it is useful to correct the charge drift in such a way that the recognized charge drift is converted into a change of the z-acceleration value. Advantageously, it is thus not necessary to exchange the mobile terminal device or to repair it.

The difference between described acceleration values B0 and B1, and the offset drift caused by the charge drift are correlated with each other. The connection between the indicated variables is specific for an existing sensor design (e.g., electric voltages, geometries, etc.). In particular, the correlation may have a simple linear form of the form:

Offsetdrift=C0+C1*(B1−B0)

with the two design-specific coefficients C0 and C1. This correlation may be used to determine a characteristic curve whose coefficients may be stored in the z-accelerometer itself or in a system of a user, and employed to correct the drift of the acceleration value. Coefficients C0, C1 are determined by suitable tests in connection with many sensors in the course of the development process.

The following steps are provided for the indicated correction of the drift of the acceleration value:

First of all, electric test signal TS is applied upon installation of the z-accelerometer in the application device, and initial acceleration value B0 is measured.

Initial acceleration value B0 is thereupon stored in the application device or in a memory (e.g., ASIC) of z-accelerometer 100.

After that, the design-specific characteristic-curve coefficients are stored in the application device or in the z-accelerometer.

Test signal TS is applied at defined intervals during the regular operation of the z-accelerometer.

The suspected drift of the acceleration value is thereupon determined with the aid of the indicated characteristic curve.

Finally, the output acceleration value of the z-accelerometer is corrected by the determined offset value.

FIG. 6 shows a flow chart in principle of one specific embodiment of the method according to the present invention.

In a step 200, a test signal is applied to an electrode 42 in order to induce a defined displacement of a rocker 10 of z-accelerometer 100 during operation of z-accelerometer 100.

In a step 210, displacements of rocker 10 are detected, and the displacements are converted into an acceleration value B1.

In a step 220, acceleration value B1 is evaluated by determining a difference between acquired z-acceleration value B1 and an initial acceleration value B0 acquired in a manufacturing process.

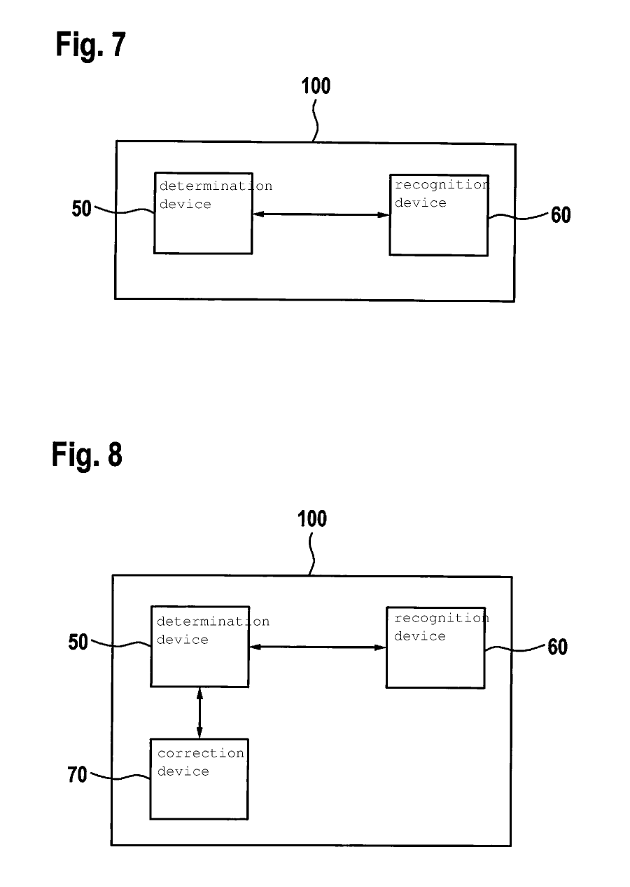

FIG. 7 shows a block diagram of one specific embodiment of micromechanical z-accelerometer 100. A determination device 50 is discernible, which is connected functionally to a recognition device 60. Acceleration values of z-accelerometer 100 are determined with the aid of determination device 50. A difference between an initial acceleration value B0 and an acceleration value B1 acquired during operation of z-accelerometer 100 is recognized with the aid of recognition device 60.

The test signal and an algorithm for recognizing and correcting an offset drift of the z-accelerometer are controlled preferably with the aid of software running on an arithmetic logic unit. In this context, the arithmetic logic unit may be located in recognition device 60, for example, or in a higher-level unit (not shown). Parameters of the indicated correlation are stored by preference in a memory (not shown) of the z-accelerometer.

FIG. 8 shows a further advantageous specific embodiment of z-accelerometer 100, which differs from that in FIG. 7 only by the fact that in this case, a correction device 70 is also provided to carry out the above-indicated correction of the acceleration value.

In summary, the present invention provides an improved method for operating a micromechanical z-accelerometer, with which it is possible to recognize charge drifts that have taken place since a manufacturing process. By recognizing the charge drift, suitable measures may be taken to allow for the recognized charge drift in the operation of the z-accelerometer.

Although the present invention has been described on the basis of concrete specific embodiments, it is by no means limited to them. One skilled in the art will recognize that various modifications are possible, which were not described or were only partially described above, without departing from the present invention.

What is claimed is:

1. A method for operating a micromechanical z-accelerometer, comprising:
applying a test signal to an electrode to induce a defined displacement of a rocker of the z-accelerometer during operation of the z-accelerometer;
detecting the displacement of the rocker and converting the displacement into an acceleration value; and
evaluating the acquired acceleration value by determining a difference between the acquired acceleration value and an initial acceleration value acquired in a manufacturing process, a difference between the acquired acceleration value and the initial acceleration value being compared to a defined threshold value and assessed.

2. The method as recited in claim 1, wherein the acceleration value is acquired repeatedly at defined time intervals.

3. The method as recited in claim 1, wherein a correlation is determined between an acceleration value acquired without applied test signal and an acceleration value acquired with applied test signal, the correlation having the following mathematical function:
Offsetdrift=C0+C1*(B1−B0)
wherein C0, C1 are design-specific coefficients, B1 is the acquired acceleration value, and B0 is the initial acceleration value; and wherein the correlation is used for a correction of the acceleration value determined during operation of the z-accelerometer.

4. The method as recited in claim 3, wherein the test signal and an algorithm for recognizing and correcting the offset drift of the z-accelerometer are controlled with the aid of a computer program product.

5. A micromechanical z-accelerometer, comprising:
a determination device to determine acceleration values of the z-accelerometer; and
a recognition device functionally connected to the determination device and designed to recognize and assess a difference between an initial acceleration value and an acceleration value acquired during operation of the z-accelerometer.

6. The micromechanical z-accelerometer as recited in claim 5, wherein the initial acceleration value and design-specific coefficients for correcting an offset drift of the acceleration value are stored in a memory of the z-accelerometer.

7. The micromechanical z-accelerometer as recited in claim 5, wherein the acceleration value is correctable with the aid of a correction device.

8. A non-transitory computer readeable storage medium on which is stored a computer program for operating a micromechanical z-accelerometer, the computer program, when executed by a control device, causing the control device to perform:
applying a test signal to an electrode to induce a defined displacement of a rocker of the z-accelerometer during operation of the z-accelerometer;
detecting the displacement of the rocker and converting the displacement into an acceleration value; and
evaluating the acquired acceleration value by determining a difference between the acquired acceleration value and an initial acceleration value acquired in a manufacturing process, a difference between the acquired acceleration value and the initial acceleration value being compared to a defined threshold value and assessed.
